(19) United States
(12) Patent Application Publication
(10) Pub. No.: US 2012/0172278 A1
(43) Pub. Date: Jul. 5, 2012

(54) STAIN PRETREATMENT AGENT

(75) Inventors: Francesca Corbellini, Koln (DE); Elisabeth Baumgarten, Duisburg (DE); Gabriele Hürtgen, Dusseldorf (DE); Matthias Sunder, Dusseldorf (DE); Robert Stephen Cappleman, Duisburg (DE); Bernhard Banowski, Dusseldorf (DE); Ralf Rönisch, Wuppertal (DE); Mathias Schriefers, Monchengladbach (DE)

(73) Assignee: Henkel AG & Co. KGaA, Dusseldorf (DE)

(21) Appl. No.: 13/417,533

(22) Filed: Mar. 12, 2012

Related U.S. Application Data
(63) Continuation of application No. PCT/EP2010/063869, filed on Sep. 21, 2010.

(30) Foreign Application Priority Data
Sep. 28, 2009 (DE) 10 2009 045 056.4

(51) Int. Cl. C11D 3/60; B43K 5/18

(52) U.S. Cl. 510/284; 510/283; 401/143

(57) ABSTRACT

The present invention relates to a stain pretreatment agent containing a mixture of a short-chain and a long-chain polyethylene glycol and to the use thereof, and to a cleaning pen containing said stain pretreatment agent.

### CROSS-REFERENCES TO RELATED APPLICATIONS

This application is a continuation of PCT/EP2010/063869, filed on Sep. 21, 2010, which claims priority under 35 U.S.C. §119 to DE 10 2009 045 056.4 filed on Sep. 28, 2009, both of which are hereby incorporated by reference.

### FIELD OF THE INVENTION

The present invention generally relates to a stain pretreatment agent containing a mixture of a short-chain and a long-chain polyethylene glycol and to the use thereof, and to a cleaning pen containing said stain pretreatment agent.

### BACKGROUND OF THE INVENTION

Pretreatment agents for stains in pen form are already described in the prior art. In comparison to other stain pretreatment agents, pretreatment agents in pen form have the advantage that they are extremely practical to use. Thus in particular they can be applied precisely to the stain to be removed.

However, a disadvantage of the pretreatment agents in pen form described in the prior art lies in the fact that because of their hexagonal structure the active ingredients do not penetrate sufficiently into the stain to be treated. A further disadvantage lies in the fact that the pens described in the prior art are very hard, with low lubricity, which makes them more difficult to apply to stains. A further disadvantage of the pens described in the prior art lies in the fact that because of the hexagonal structure the non-ionic surfactants exude. This causes the material of the agent to pack against the casing of the pen, making it very difficult or impossible to retract it into the casing after application.

The object of the present invention was therefore to provide a stain pen that differs advantageously from the stain pens described in the prior art, in particular by the fact that the material of the treatment agent is easier to apply to the textile to be treated and/or the pen can be extended out of and/or retracted into the pen casing more easily and/or that exudation of components, in particular of non-ionic surfactants, is largely avoided and/or that the stain pen is more dimensionally stable than the stain pens described in the prior art.

Furthermore, other desirable features and characteristics of the present invention will become apparent from the subsequent detailed description of the invention and the appended claims, taken in conjunction with this background of the invention.

### BRIEF SUMMARY OF THE INVENTION

A stain pretreatment agent, wherein it contains a mixture of a short-chain polyethylene glycol having a molecular weight from 100 to 800 g/mol and a long-chain polyethylene glycol having a molecular weight from 2000 to 8000 g/mol, the total quantity of polyethylene glycols being from 25 to 60 wt. %, preferably 30 to 55 wt. % and in particular 35 to 50 wt. %.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

Surprisingly it has now been found that the object of the present invention can be achieved outstandingly by a mixture comprising a short-chain polyethylene glycol and a long-chain polyethylene glycol.

The present invention therefore provides a stain pretreatment agent wherein it contains a mixture of at least one short-chain polyethylene glycol having a molecular weight from 100 to 800 g/mol, preferably 200 to 700 g/mol, particularly preferably 300 to 500 g/mol, in particular 350 to 450 g/mol, and at least one long-chain polyethylene glycol having a molecular weight from 2000 to 8000 g/mol, preferably 2500 to 7000 g/mol, particularly preferably 3000 to 5000 g/mol, in particular 3500 to 4500 g/mol, the total quantity of polyethylene glycols in the agent being 25 to 60 wt. %, preferably 30 to 55 wt. % and in particular 35 to 50 wt. %.

The molar proportion of long-chain polyethylene glycol relative to the total quantity of polyethylene glycols is preferably from 0.05 to 20%, particularly preferably from 0.1 to 10%, in particular from 0.2 to 2%.

According to the invention the stain pretreatment agent is preferably in solid form. Solid form is understood to mean here in particular that it is not in liquid form. The stain pretreatment agent can however be in any solid state of aggregation. The solid form can also above all be a formable material. The stain pretreatment agent is particularly preferably a waxy material.

In a preferred embodiment the stain pretreatment agent according to the invention is in the form of a circular cylinder, but it can also be used in the form of a cube, for example, or in any other form.

In a preferred embodiment the viscosity of a stain pretreatment agent according to the invention measured using an EIC VISCO-Plot cone and plate viscometer from Epprecht Instruments and Controls AG, Switzerland, with an REL cone and plate and the D sensor at 20 rpm, 100° C. (setting 1) and 1 bar, is at least 10,000 mPas, particularly preferably at least 20,000 mPas, in particular from 25,000 to 125,000 mPas.

A stain pretreatment agent according to the invention preferably also contains fatty acids, in particular in a quantity from 2 to 10 wt. %. The fatty acids for use according to the invention are preferably C₁₀₋₂₂ fatty acids, in particular C₁₄₋₂₀ fatty acids, particularly preferably C₁₆₋₁₈ fatty acids.

It has emerged that the properties of the stain pretreatment agent, in particular the lubricity of the pen and the penetrating ability of the active ingredients, can be further improved if a mixture of saponified and unsaponified fatty acids is used.

It has proved to be particularly advantageous for the molar proportion of non-saponified fatty acids relative to the total quantity of fatty acids to be 0.1 to 20%, in particular 0.5 to 10%.

A stain pretreatment agent according to the invention preferably also contains surfactants. Surfactants are preferably included in an agent according to the invention in a quantity from 10 to 30 wt. %, in particular from 15 or 20 to 25 wt. %.

According to the invention the surfactants are preferably selected from anionic, non-ionic, cationic and amphoteric surfactants. In a preferred embodiment anionic or non-ionic surfactants or mixtures thereof are used.

All non-ionic surfactants known to the person skilled in the art can be used as non-ionic surfactants. Slightly foaming non-ionic surfactants are used as preferred surfactants. Washing or cleaning agents contain to particular advantage non-ionic surfactants from the group of alkoxylated alcohols. Alkoxylated, advantageously ethoxylated, in particular primary alcohols having preferably 8 to 18 C atoms and on average 1 to 12 mol of ethylene oxide (EO) per mol of alcohol are preferably used as non-ionic surfactants, in which the alcohol residue can be linear or preferably methyl-branched in the 2-position or can contain linear and methyl-branched residues in the mixture, such as are conventionally present in oxoalcohol residues. However, alcohol ethoxylates containing linear residues from alcohols of native origin having 12 to 18 C atoms, for example from coconut, palm, tallow or oleyl alcohol, and on average 2 to 8 mol of EO per mol of alcohol are preferred in particular. The preferred ethoxylated alcohols include, for example, C₁₂₋₁₄ alcohols having 3 EO or 4 EO, C₉₋₁₁ alcohol having 7 EO, C₁₃₋₁₅ alcohols having 3 EO, 5 EO, 7 EO or 8 EO, C₁₂₋₁₈ alcohols having 3 EO, 5 EO or 7 EO and mixtures thereof, such as mixtures of C₁₂₋₁₄ alcohol having 3 EO and C₁₂₋₁₈ alcohol having 5 EO. The specified degrees of ethoxylation are statistical averages which for an individual product can correspond to a whole number or a fraction. Preferred alcohol ethoxylates have a narrow homolog distribution (narrow-range ethoxylates, NRE). Alternatively or in addition to these non-ionic surfactants, fatty alcohols having more than 12 EO can also be used. Examples thereof are tallow fatty alcohol having 14 EO, 25 EO, 30 EO or 40 EO.

Alkyl glycosides of the general formula RO(G)ₓ can moreover be used as further non-ionic surfactants, in which R corresponds to a primary straight-chain or methyl-branched aliphatic residue, in particular one methyl-branched in the 2-position, having 8 to 22, preferably 12 to 18 C atoms, and G is the symbol denoting a glycose unit having 5 or 6 C atoms, preferably glucose. The degree of oligomerization x, which indicates the distribution of monoglycosides and oligoglycosides, is any number between 1 and 10; x is preferably 1.2 to 1.4.

Another class of preferably used non-ionic surfactants, which are used either as the only non-ionic surfactant or in combination with other non-ionic surfactants, is alkoxylated, preferably ethoxylated or ethoxylated and propoxylated, fatty acid alkyl esters, preferably having 1 to 4 carbon atoms in the alkyl chain.

Non-ionic surfactants of the amine oxide type, for example N-cocoalkyl-N,N-dimethyl amine oxide and N-tallow alkyl-N,N-dihydroxyethyl amine oxide, and of the fatty acid alkanol amide type can also be suitable. The quantity of these non-ionic surfactants is preferably no more than that of the ethoxylated fatty alcohols, in particular no more than half that.

Other suitable surfactants are polyhydroxy fatty acid amides of the formula

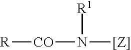

in which R denotes an aliphatic acyl residue having 6 to 22 carbon atoms, R¹ denotes hydrogen, an alkyl or hydroxyalkyl residue having 1 to 4 carbon atoms and [Z] denotes a linear or branched polyhydroxyalkyl residue having 3 to 10 carbon atoms and 3 to 10 hydroxyl groups. The polyhydroxy fatty acid amides are known substances which can conventionally be obtained by reductive amination of a reducing sugar with ammonia, an alkyl amine or an alkanol amine and subsequent acylation with a fatty acid, a fatty acid alkyl ester or a fatty acid chloride.

The group of polyhydroxy fatty acid amides also includes compounds of the formula

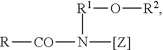

in which R denotes a linear or branched alkyl or alkenyl residue having 7 to 12 carbon atoms, R¹ denotes a linear, branched or cyclic alkyl residue or an aryl residue having 2 to 8 carbon atoms and R² denotes a linear, branched or cyclic alkyl residue or an aryl residue or an oxyalkyl residue having 1 to 8 carbon atoms, C₁₋₄ alkyl or phenyl residues being preferred, and [Z] denotes a linear polyhydroxyalkyl residue, whose alkyl chain is substituted with at least two hydroxyl groups, or alkoxylated, preferably ethoxylated or propoxylated derivatives of this residue.

[Z] is preferably obtained by reductive amination of a reduced sugar, for example glucose, fructose, maltose, lactose, galactose, mannose or xylose. The N-alkoxy- or N-aryloxy-substituted compounds can be converted into the desired polyhydroxy fatty acid amides by reaction with fatty acid methyl esters in the presence of an alkoxide as catalyst.

Furthermore, combinations of one or more tallow fatty alcohols having 20 to 30 EU and silicone defoaming agents are used to particular advantage.

Non-ionic surfactants from the group of alkoxylated alcohols, particularly preferably from the group of mixed alkoxylated alcohols and in particular from the group of EO/AO/EO non-ionic surfactants, or PO/AO/PO non-ionic surfactants, especially PO/EO/PO non-ionic surfactants, are particularly preferred. Such PO/EO/PO non-ionic surfactants are distinguished by very good foam control.

Surfactants of the sulfonate and sulfate type for example are used as anionic surfactants. Suitable surfactants of the sulfonate type are preferably C₉₋₁₃ alkylbenzene sulfonates, olefin sulfonates, i.e. mixtures of alkene and hydroxyalkane sulfonates, and disulfonates, such as are obtained for example from C₁₂₋₁₈ monoolefins having a terminal or internal double bond by sulfonation with gaseous sulfur trioxide and subsequent alkaline or acid hydrolysis of the sulfonation products. Also suitable are alkane sulfonates obtained from C₁₂₋₁₈ alkanes, for example by sulfochlorination or sulfoxidation with subsequent hydrolysis or neutralization. Likewise suitable are the esters of α-sulfo fatty acids (ester sulfonates), for example the α-sulfonated methyl esters of hydrogenated coconut, palm kernel or tallow fatty acids.

Other suitable anionic surfactants are sulfonated fatty acid glycerol esters. Fatty acid glycerol esters are understood to be the mono-, di- and triesters and mixtures thereof, such as are obtained in the production by esterification of a monoglycerol having 1 to 3 mol of fatty acid or in the transesterification of triglycerides having 0.3 to 2 mol of glycerol. Preferred sulfonated fatty acid glycerol esters are the sulfonation products of saturated fatty acids having 6 to 22 carbon atoms, for example of hexanoic acid, octanoic acid, decanoic acid, myristic acid, lauric acid, palmitic acid, stearic acid or docosanoic acid.

The alkali and in particular the sodium salts of the sulfuric acid semi-esters of C₁₂-C₁₈ fatty alcohols, for example of coconut fatty alcohol, tallow fatty alcohol, lauryl, myristyl, cetyl or stearyl alcohol, or of C₁₀-C₂₀ oxoalcohols and the semi-esters of secondary alcohols having these chain lengths are preferred as alk(en)yl sulfates. Also preferred are alk(en)yl sulfates of the specified chain length containing a synthetic, straight-chain alkyl residue produced on a petrochemical basis, which have an analogous decomposition behavior to the appropriate compounds based on fat chemistry raw materials. From a detergent perspective the C₁₂-C₁₆ alkyl sulfates and C₁₂-C₁₅ alkyl sulfates and C₁₄-C₁₅ alkyl sulfates are preferred. 2,3-Alkyl sulfates, which can be obtained as commercial products from the Shell Oil Company under the name DAN °, are also suitable anionic surfactants.

The sulfuric acid monoesters of the straight-chain or branched C₇₋₂₁ alcohols ethoxylated with 1 to 6 mol of ethylene oxide, such as 2-methyl-branched C₉₋₁₁ alcohols having on average 3.5 mol of ethylene oxide (EO) or C₁₂₋₁₈ fatty alcohols having 1 to 4 EO, are also suitable. Owing to their high foaming characteristics they are used in cleaning agents in only relatively small quantities, for example in quantities from 1 to 5 wt. %.

Other suitable anionic surfactants are also the salts of alkyl sulfosuccinic acid, which are also known as sulfosuccinates or sulfosuccinic acid esters, and the monoesters and/or diesters of sulfosuccinic acid with alcohols, preferably fatty alcohols and in particular ethoxylated fatty alcohols. Preferred sulfosuccinates contain C₈₋₁₈ fatty alcohol residues or mixtures thereof. Sulfosuccinates that are preferred in particular contain a fatty alcohol residue derived from ethoxylated fatty alcohols which are non-ionic surfactants in their own right. Once again, sulfosuccinates whose fatty alcohol residues derive from ethoxylated fatty alcohols having a narrow homolog distribution are particularly preferred. It is likewise also possible to use alk(en)yl succinic acid having preferably 8 to 18 carbon atoms in the alk(en)yl chain or salts thereof.

Other suitable anionic surfactants are in particular soaps. Saturated fatty acid soaps are suitable, such as the salts of lauric acid, myristic acid, palmitic acid, stearic acid, hydrogenated erucic acid and docosanoic acid, and in particular soap mixtures derived from natural fatty acids, for example coconut, palm kernel or tallow fatty acids.

The anionic surfactants including the soaps can be present in the form of their sodium, potassium or ammonium salts and as soluble salts of organic bases, such as mono-, di- or triethanolamine. The anionic surfactants are preferably in the form of their sodium or potassium salts, in particular in the form of their sodium salts.

In an embodiment that is particularly preferred according to the invention, the aforementioned fatty alcohol ethoxylates are used as surfactants.

A stain pretreatment agent according to the invention moreover preferably contains at least one wax component. Wax is preferably contained in a stain pretreatment agent according to the invention in a quantity from 0.01 to 0.5 wt. %.

According to the invention solid paraffins or isoparaffins, plant waxes such as candelilla wax, carnauba wax, esparto grass wax, Japan wax, cork wax, sugar cane wax, ouricury wax, montan wax, sunflower wax, fruit waxes and animal waxes, for example beeswax and other insect waxes, spermaceti wax, shellac wax, wool wax and uropygial fat, also mineral waxes, such as for example ceresin and ozokerite or the petrochemical waxes, such as for example petroleum jelly, paraffin waxes, polyethylene or polypropylene microwaxes and polyethylene glycol waxes. It can be advantageous to use hydrogenated or hardened waxes. Chemically modified waxes, in particular hard waxes such as for example montan ester waxes, Sasol waxes and hydrogenated jojoba waxes, can also be used.

Also suitable are the mono-, di- and triglycerides of saturated and optionally hydroxylated C₁₆₋₃₀ fatty acids, such as for example hydrogenated triglyceride fats (hydrogenated palm oil, hydrogenated coconut oil, hydrogenated castor oil), glyceryl monostearate (Cutina® MD), glyceryl tribehenate or glyceryl tri-12-hydroxystearate, also synthetic full esters of fatty acids and glycols (e.g. Syncrowachs®) or polyols having 2 to 6 C atoms, fatty acid monoalkanol amides having a C₁₂₋₂₂ acyl residue and a C₂₋₄ alkanol residue, esters of saturated and/or unsaturated, branched and/or unbranched alkane carboxylic acids with a chain length from 1 to 80 C atoms and saturated and/or unsaturated, branched and/or unbranched alcohols with a chain length from 1 to 80 C atoms, including for example synthetic fatty acid fatty alcohol esters such as stearyl stearate or cetyl palmitate, esters of aromatic carboxylic acids, dicarboxylic acids or hydroxycarboxylic acids (e.g. 12-hydroxystearic acid) and saturated and/or unsaturated, branched and/or unbranched alcohols with a chain length from 1 to 80 C atoms, lactides of long-chain hydroxycarboxylic acids and full esters of fatty alcohols and di- and tricarboxylic acids, e.g. dicetyl succinate or dicetyl/stearyl adipate, and mixtures of these substances, provided that the individual wax components or the mixture thereof is/are solid at room temperature.

It is particularly preferable to choose the wax component from the group of esters of saturated, unbranched alkane carboxylic acids with a chain length from 14 to 44 C atoms and saturated, unbranched alcohols with a chain length from 14 to 44 C atoms, provided that the wax component or the entirety of the wax components is solid at room temperature. The wax components from the group of C₁₆₋₃₆ alkyl stearates, the C₁₀₋₄₀ alkyl stearates, the C₂₋₄₀ alkyl isostearates, the C₂₀₋₄₀ dialkyl esters of dimeric acids, the C₁₈₋₃₈ alkyl hydroxystearoyl stearates, the C₂₀₋₄₀ alkyl erucates can particularly advantageously be chosen; in addition, C₃₀₋₅₀ alkyl beeswax and cetearyl behenate can be used. Silicone waxes, for example stearyl trimethylsilane/stearyl alcohol are optionally also advantageous. Particularly preferred wax components are the esters of saturated, monohydric C₂₀-C₆₀ alcohols and saturated C₈-C₃₀ monocarboxylic acids, in particular a C₂₀-C₄₀ alkyl stearate that is available under the name Kesterwachs® K82H from Koster Keunen Inc. The wax or the wax components should be solid at 25° C. but melt in the range from 35 to 95° C., a range from 45 to 85° C. being preferred.

Natural, chemically modified and synthetic waxes can be used alone or in combination.

The quantity of water in a stain pretreatment agent according to the invention is preferably from 10 to 35 wt. %.

In a preferred embodiment a stain pretreatment agent according to the invention furthermore contains at least one non-aqueous solvent in a quantity from 0.5 to 5 wt. %, in particular 1 to 3 wt. %, the non-aqueous solvent preferably being selected from butylene glycol and propylene glycol.

A stain pretreatment agent according to the invention can furthermore also contain particular components that indicate the application of the stain pretreatment agent on the textile. Dyes are suitable for this purpose, for example, but in particular also glitters such as for example Timiron Diamond Cluster MP-149 (Merck).

The pH of such a stain pretreatment agent according to the invention is preferably 7 to 11, in particular 8 to 10, particularly preferably from 9 to 10.

A stain pretreatment agent according to the invention can also contain further conventional washing agent components, selected in particular from the group consisting of builders, bleaching agents, bleach catalysts, bleach activators, enzymes, enzyme stabilizers, electrolytes, pH adjusters, scents, perfume carriers, fluorescent agents, dyes, thickeners, disintegrating (auxiliary) agents, hydrotropes, foam inhibitors, silicone oils, soil release polymers, graying inhibitors, optical brighteners, anti-shrink agents, anti-crease agents, dye transfer inhibitors, antimicrobial active ingredients, germicides, fungicides, antioxidants, preservatives, corrosion inhibitors, antistatics, bittering agents, ironing aids, phobing and impregnating agents, non-swelling and anti-slip agents, softening components, heavy metal complexing agents, abrasives, fillers, blowing agents and UV absorbers.

An advantage of the stain pretreatment agent according to the invention lies in the fact that a soiled item of laundry that has been pretreated with the agent according to the invention does not necessarily have to be washed immediately. Whereas a maximum contact period of 10 minutes is recommended for commercial pretreatment agents, the contact period for the agent according to the invention is unrestricted. With the known agents a longer contact period can damage the fibers, whereas fiber damage does not occur even after an extended contact period with the agent according to the invention. In addition, the soiling in stains treated with the gentle agent according to the invention does not fix more strongly in the fibers over a longer contact period, and the stain does not dry out. The soiled textile that has already been pretreated with the agent according to the invention can be stored for 24 hours or more, for example in a laundry basket, before being washed in an automatic washing machine or hand washed. This has the advantage that stains can be treated with the agent according to the invention immediately after they occur or are noticed and the item of laundry can then be stored in the laundry basket with the other washing until the next wash. This prevents the stain from being overlooked and eliminates a laborious search for the stain for pretreatment before the next wash. There is likewise no need for a premature wash, for example in an automatic washing machine without a full load because not enough laundry has accumulated yet, thus saving work and conserving resources.

The present invention also provides a cleaning pen containing a stain pretreatment agent according to the invention, wherein the cleaning pen has a casing and the stain pretreatment agent can be moved along the longitudinal axis of the casing preferably by means of a manually adjustable dosing system.

The present invention likewise provides a method for cleaning textiles, wherein in one process step the textile is brought into contact with a stain pretreatment agent according to the invention, preferably using a cleaning pen according to the invention.

### EMBODIMENT EXAMPLES

### Example 1

### Formulations

TABLE 1

| Component | A | B | C | D | E | F | G | H | l |
|---|---|---|---|---|---|---|---|---|---|
| C₁₆-C₁₈ fatty acid | 3.5 | 3.5 | 4.0 | 4.0 | 4.0 | 4.5 | 4.5 | 5.0 | 5.0 |
| PEG 400 | 40 | 38 | 38 | 37 | 45.5 | 36 | 34 | 32 | 30 |
| PEG 4000 | 2.0 | 1.8 | 1.5 | 1.4 | 1.5 | 2.0 | 1.8 | 1.5 | 1.4 |
| 1,3-Butylene glycol | 1.8 | 2.0 | 2.4 | 2.2 | 2.4 | 1.8 | 2.0 | 2.4 | 2.2 |
| Polydimethyl siloxane | 0.1 | 0.1 | 0.1 | 0.1 | 0.1 | 0.1 | 0.1 | 0.1 | 0.1 |
| Sodium hydroxide | 0.4 | 0.5 | 0.5 | 0.8 | 0.5 | 0.8 | 0.6 | 0.6 | 0.4 |
| solution | | | | | | | | | |
| C₁₂-C₁₈ fatty alcohol | 18 | 16 | 15 | 14 | 15 | 17 | 15 | 14 | 14 |
| with 7 EO | | | | | | | | | |
| C₁₂-C₁₄ fatty alcohol | 7 | 6 | 5 | 5 | 5 | 4 | 4 | 6 | 6 |
| with 2 EO | | | | | | | | | |
| C₁₂-C₁₄ isoparaffin | − | 1 | − | − | − | 1 | − | − | 1 |
| Enzyme | − | − | − | − | − | + | + | − | − |
| Preservative | + | + | + | + | + | + | + | + | + |
| Perfume | + | + | + | + | + | + | + | + | + |
| Water | to 100 | to 100 | to 100 | to 100 | to 100 | to 100 | to 100 | to 100 | to 100 |

The quantities are given in wt. %.

### Example 2

### Assessment of the Performance of Formulation E as Compared with a Commercial Stain Pretreatment Agent

To assess the performance as compared with a commercial stain pen, a stain pretreatment agent according to the invention according to formulation E was compared with a commercial stain pretreatment agent. To this end the stain pretreatment agents were each applied to bleachable stains and to fat/pigment stains (both on cotton). After the contact period (10 minutes) the textiles were subjected to a washing process with a commercial textile washing agent. The intensity of the stains after the washing process was determined photometrically using a Minolta CR 200 camera. The lightness values after the washing process (Y value measurement) are shown in Table 2. The higher the value, the greater the lightening achieved.

TABLE 2

| | Bleachable | Fat/pigment |
|---|---|---|
| Laundry treatment | stains | stains |
| Washing without stain pretreatment | 68.8 | 64.1 |
| Stain pretreatment with commercial agent | 67.9 | 65.8 |
| Stain pretreatment with formulation E | 71.3 | 66.6 |

It can be seen that when a stain pretreatment agent according to the invention was used, a significant increase in the cleaning performance was able to be achieved in comparison to the use of a commercial stain pretreatment agent, with regard both to the tested bleachable stains and to the tested fat/pigment stains.

### Example 3

### Performance of Formulation E after Varying Contact Times, Using the Example of Fat/Pigment Stains

The stain pretreatment agent according to formulation E was applied to fat/pigment stains (on cotton). After varying contact periods (10 minutes, 20 minutes and 24 hours) the textiles were subjected to a washing process with a commercial textile washing agent. The lightness values after the washing process are shown in Table 3 (determined as described in Example 2).

TABLE 3

| Contact period | Lightness values |
|---|---|
| 10 minutes | 66.6 |
| 20 minutes | 66.7 |
| 24 hours | 67.4 |

It can be seen that the cleaning performance of the stain pretreatment agent according to the invention does not decrease as the contact period increases but actually improves further.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A stain pretreatment agent comprising a mixture of short-chain polyethylene glycol having a molecular weight from 100 to 800 g/mol and long-chain polyethylene glycol having a molecular weight from 2000 to 8000 g/mol, wherein the total quantity of polyethylene glycols being from 25 to 60 wt. %.

2. The stain pretreatment agent according to claim 1, wherein the molar proportion of long-chain polyethylene glycol relative to the total quantity of polyethylene glycols is 0.05 to 20%.

3. The stain pretreatment agent according to claim 1 further comprising fatty acids in a quantity from 2 to 10 wt. %.

4. The stain pretreatment agent according to claim 3 wherein the fatty acids comprise a mixture of saponified and non-saponified fatty acids.

5. The stain pretreatment agent according to claim 4, wherein the molar proportion of non-saponified fatty acids relative to the total quantity of fatty acids is 0.1 to 20%.

6. The stain pretreatment agent according to claim 3, wherein the fatty acids are selected from C₁₀₋₂₂ fatty acids.

7. The stain pretreatment agent according to claim 1, further comprising surfactants in a quantity from 10 to 30 wt. %.

8. The stain pretreatment agent according to claim 7, wherein the surfactants are fatty alcohol ethoxylates.

9. The stain pretreatment agent according to claim 1 further comprising 0.01 to 0.5 wt. % wax.

10. The stain pretreatment agent according to claim 1 comprising 10 to 35 wt. % water.

11. The stain pretreatment agent according to claim 1 comprising at least one non-aqueous solvent in a quantity from 0.5 to 5 wt. %.

12. The stain pretreatment agent according to claim 11, wherein the solvent is selected from butylene glycol and propylene glycol.

13. The stain pretreatment agent according to claim 1, wherein the pH is from 7 to 11.

14. A cleaning pen containing a stain pretreatment agent according to claim 1, wherein the cleaning pen has a casing and the stain pretreatment agent can be moved along the longitudinal axis of the casing by means of a manually adjustable dosing system.

15. A method for cleaning textiles, wherein in one process step the textile is brought into contact with a stain pretreatment agent according to claim 1.
